(19) United States
(12) Patent Application Publication
(10) Pub. No.: US 2020/0322987 A1
(43) Pub. Date: Oct. 8, 2020

(54) Switching Between Load-Based Mode And Frame-Based Mode When Operating In Unlicensed Band In Mobile Communications

(71) Applicant: MediaTek Singapore Pte. Ltd., Singapore (SG)

(72) Inventor: Timothy Perrin Fisher-Jeffes, San Jose, CA (US)

(21) Appl. No.: 16/836,917

(22) Filed: Apr. 1, 2020

Related U.S. Application Data
(60) Provisional application No. 62/827,915, filed on Apr. 2, 2019.

(51) Int. Cl. H04W 74/08; H04W 16/14; H04W 74/00

(52) U.S. Cl. CPC H04W 74/0808; H04W 74/006; H04W 16/14

(57) ABSTRACT

Examples pertaining to switching between load-based mode and frame-based mode when operating in unlicensed band in mobile communications are described. An apparatus implemented in a user equipment (UE) establishes wireless communication with a network in an unlicensed band. The apparatus determines to switch between a load-based equipment (LBE) mode and a frame-based equipment (FBE) mode. The apparatus then switches between the LBE mode and the FBE mode in response to the determining.

### CROSS REFERENCE TO RELATED PATENT APPLICATION(S)

The present disclosure is part of a non-provisional application claiming the priority benefit of U.S. Patent Application No. 62/827,915, filed on 2 Apr. 2019, the content of which being incorporated by reference in its entirety.

### TECHNICAL FIELD

The present disclosure is generally related to mobile communications and, more particularly, to techniques pertaining to switching between load-based mode and frame-based mode when operating in unlicensed band in mobile communications.

### BACKGROUND

Unless otherwise indicated herein, approaches described in this section are not prior art to the claims listed below and are not admitted as prior art by inclusion in this section.

In wireless communications, currently load-based equipment (LBE) mode of operation is the incumbent mode in which the majority of wireless devices operate such as, for examine, in the cases of Wi-Fi and licensed-assisted access (LAA) under the 3^{rd} Generation Partnership Project (3GPP) specifications. However, without decoding the Wi-Fi preamble or LAA neighbor cell configuration, an LAA-compliant device would have no way of knowing how long a competing Wi-Fi/LAA device would occupy a channel. Consequently, there would be no way for such LAA device to know how long it may be able to stay in a sleep or low-power mode, and it would be power consuming for the device to continuously and/or repeatedly sense the channel for extended period(s) of time.

On the other hand, frame-based equipment (FBE) adaptivity only mandates a single 9 μs sensing period recurring immediately prior to a defined fixed frame period (FFP). This would result in reduced complexity and lower power consumption in sensing the channel. However, a network is typically set up and initialized as either a LBE network or a FBE network, but not both. Therefore, there is a need for a solution to switch between LBE mode and FBE mode.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is to propose various schemes, concepts, designs, techniques, methods and apparatuses to address the aforementioned issue. In particular, the present disclosure aims to provide schemes to allow for both FBE mode and LBE mode of operations and for a network to choose when to leverage the benefits of either mode and to switch from one mode to the other as the network deems appropriate or necessary.

In one aspect, a method may involve a processor of an apparatus, implemented in a user equipment (UE), establishing wireless communication with a network in an unlicensed band. The method may also involve the processor determining to switch between a load-based equipment (LBE) mode and a frame-based equipment (FBE) mode. The method may further involve the processor switching between the LBE mode and the FBE mode responsive to the determining.

In another aspect, a method may involve a processor of an apparatus, implemented in a network node of a network, establishing wireless communication with a UE in an unlicensed band. The method may also involve the processor determining a need to switch between a LBE mode and a FBE mode. The method may further involve the processor transmitting a message to the UE which is capable of driving the UE to switch between the LBE mode and the FBE mode.

In yet another aspect, an apparatus implemented in a FBE may include a transceiver and a processor coupled to the transceiver. The transceiver may be configured to communicate with a network. The processor may be configured to establish, via the transceiver, wireless communication with the network in an unlicensed band. The processor may be also configured to determine to switch between a LBE mode and a FBE mode. The processor may be further configured to switch between the LBE mode and the FBE mode responsive to the determining.

It is noteworthy that, although description provided herein may be in the context of certain radio access technologies, networks and network topologies such as 5^{th} Generation (5G)/New Radio (NR) mobile networking, the proposed concepts, schemes and any variation(s)/derivative(s) thereof may be implemented in, for and by other types of wireless and wired communication technologies, networks and network topologies such as, for example and without limitation, Ethernet, Evolved Packet System (EPS), Universal Terrestrial Radio Access Network (UTRAN), Evolved UTRAN (E-UTRAN), Global System for Mobile communications (GSM), General Packet Radio Service (GPRS)/Enhanced Data rates for Global Evolution (EDGE) Radio Access Network (GERAN), Long-Term Evolution (LTE), LTE-Advanced, LTE-Advanced Pro, Internet-of-Things (IoT), Industrial Internet-of-Things (IIoT), Narrow Band Internet of Things (NB-IoT), and any future-developed networking technologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various solutions and schemes in accordance with the present disclosure may be implemented.

FIG. 2 is a block diagram of an example communication system in accordance with an implementation of the present disclosure.

FIG. 3 is a flowchart of an example process in accordance with an implementation of the present disclosure.

FIG. 4 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to switching between load-based mode and frame-based mode when operating in unlicensed band in mobile communications. According to the present disclosure, a number of possible solutions may be implemented separately or jointly. That is, although these possible solutions may be described below separately, two or more of these possible solutions may be implemented in one combination or another.

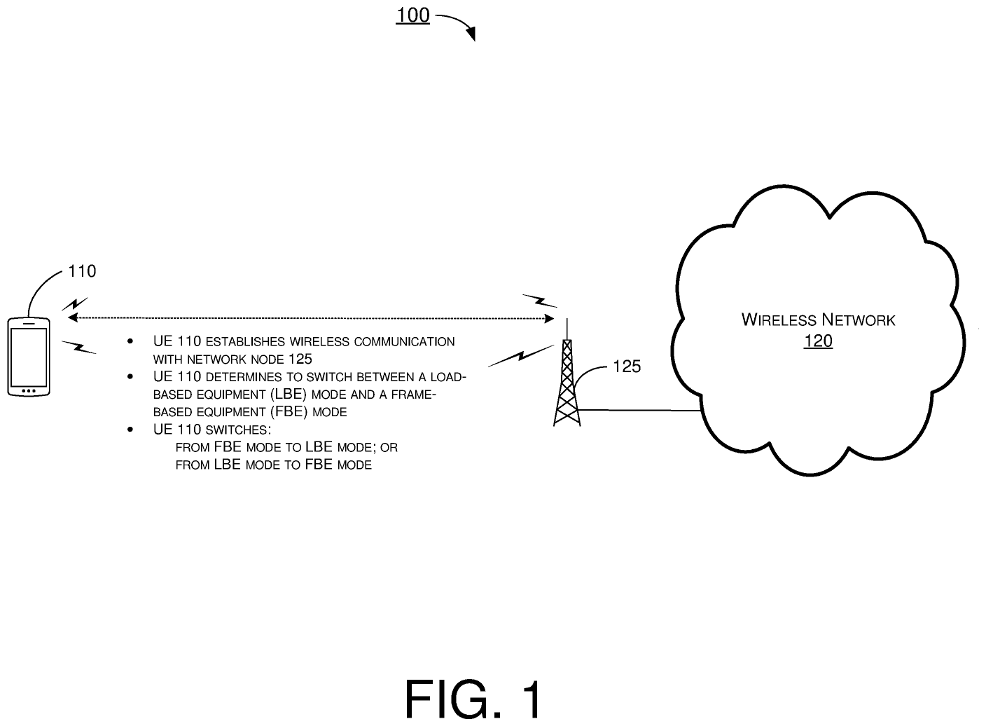

FIG. 1 illustrates an example network environment 100 in which various solutions and schemes in accordance with the present disclosure may be implemented. Referring to FIG. 1, network environment 100 may involve a UE 110 in wireless communication with a wireless network 120 (e.g., a 5G NR mobile network). UE 110 may be in wireless communication with wireless network 120 via a base station or network node 125 (e.g., an eNB, gNB or transmit-receive point (TRP)). In network environment 100, UE 110 and wireless network 120 may implement various schemes pertaining to switching between load-based mode and frame-based mode when operating in unlicensed band in mobile communications in accordance with the present disclosure, as described herein.

Currently, LBE clear carrier assessment (CCA) sensing procedures as defined by the European Telecommunications Standards Institute (ETSI) in ETSI EN regulations tend to cause high power consumption on the part of UEs. ETSI EN regulations do not yet explicitly prevent switching between LBE mode and FBE mode. A device or UE needs to declare what type of device (whether LBE or FBE) it is, although there is no exclusion for declaring both.

Under a proposed scheme in accordance with the present disclosure, UE 110 may switch between operating in the FBE mode and operating in the LBE mode (e.g., from FBE mode to LBE mode or from LBE mode to FBE mode). For instance, based on a result of sensing other neighboring devices, UE 110 may determine in which mode it is to operate. Some advantages associated with operating in the FBE mode may include, for example and without limitation, lower power consumption during carrier/channel sensing, enablement of advanced coordinated receiver architectures such as coordinated multipoint (CoMP), simpler implementation, and similarity to 3GPP synchronous operation.

Under the proposed scheme, message transmitted by network node 125 (e.g., to UE 110 and other UEs (not shown)) to reconfigure an entire cell associated with network node 125 from one mode to the other (e.g., from FBE mode to LBE mode or from LBE mode to FBE mode) may entail the same or similar information as required on initial setup using system information block (SIB) messages. For instance, such reconfiguration messages may be transmitted by network node 125 to all UEs in the cell in preparation for the switch. The messages to switch from LBE mode to FBE mode may include FFP and also the start position of the FFP (e.g., offset) for FBE mode. This may be moved to a dynamic mode where a message is carried by a radio resource control (RRC) configuration, as is done for LBE mode.

Under a proposed scheme in accordance with the present disclosure, UE 110 may determine to switch between LBE mode and FBE mode upon detecting one or more conditions. For instance, UE 110 may determine to switch from LBE mode to FBE mode upon detecting one or more of the following: (a) other than apparatus 210, there being no other UE operating on an operating frequency; (b) the operating frequency being occupied by multiple UEs operating in the LBE mode and using a priority class access with a same transmit opportunity (TXOP); (c) the operating frequency being occupied by a number of UEs with the number being less than a threshold; (d) a need for apparatus 210 to conserve power; and (e) one or more other UEs operating near full buffer. Moreover, UE 110 may determine to switch from FBE mode to LBE mode upon detecting either or both of the following: (a) there being high-priority data for transmission; and (b) an operating frequency is fully occupied by a plurality of UEs that are operating at different access priorities and different TXOP lengths.

### Illustrative Implementations

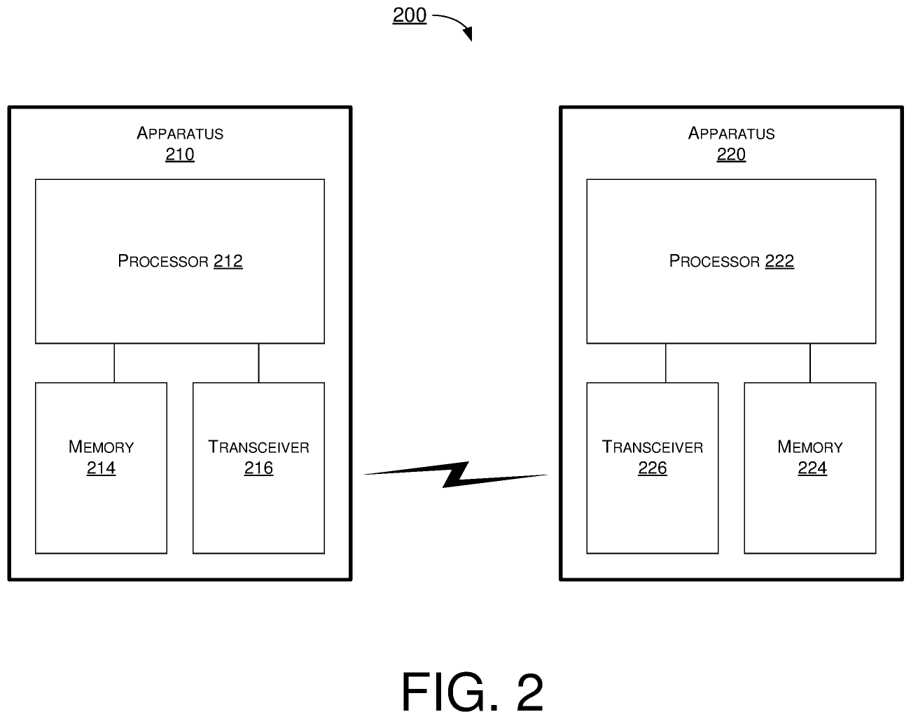

FIG. 2 illustrates an example communication system 200 having at least an example apparatus 210 and an example apparatus 220 in accordance with an implementation of the present disclosure. Each of apparatus 210 and apparatus 220 may perform various functions to implement schemes, techniques, processes and methods described herein pertaining to switching between load-based mode and frame-based mode when operating in unlicensed band in mobile communications, including the various schemes described above with respect to various proposed designs, concepts, schemes, systems and methods described above, including network environment 100, as well as processes described below.

Each of apparatus 210 and apparatus 220 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 210 and apparatus 220 may be implemented in a smartphone, a smart watch, a personal digital assistant, an electronic control unit (ECU) in a vehicle, a digital camera, or a computing equipment such as a tablet computer, a laptop computer or a notebook computer. Each of apparatus 210 and apparatus 220 may also be a part of a machine type apparatus, which may be an IoT apparatus such as an immobile or a stationary apparatus, a home apparatus, a roadside unit (RSU), a wire communication apparatus or a computing apparatus. For instance, each of apparatus 210 and apparatus 220 may be implemented in a smart thermostat, a smart fridge, a smart door lock, a wireless speaker or a home control center. When implemented in or as a network apparatus, apparatus 210 and/or apparatus 220 may be implemented in an eNodeB in an LTE, LTE-Advanced or LTE-Advanced Pro network or in a gNB or TRP in a 5G network, an NR network or an IoT network.

In some implementations, each of apparatus 210 and apparatus 220 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 210 and apparatus 220 may be implemented in or as a network apparatus or a UE. Each of apparatus 210 and apparatus 220 may include at least some of those components shown in FIG. 2 such as a processor 212 and a processor 222, respectively, for example. Each of apparatus 210 and apparatus 220 may further include one or more other components not pertinent to the proposed scheme of the present disclosure (e.g., internal power supply, display device and/or user interface device), and, thus, such component(s) of apparatus 210 and apparatus 220 are neither shown in FIG. 2 nor described below in the interest of simplicity and brevity.

In one aspect, each of processor 212 and processor 222 may be implemented in the form of one or more single-core processors, one or more multi-core processors, or one or more CISC or RISC processors. That is, even though a singular term “a processor” is used herein to refer to processor 212 and processor 222, each of processor 212 and processor 222 may include multiple processors in some implementations and a single processor in other implementations in accordance with the present disclosure. In another aspect, each of processor 212 and processor 222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 212 and processor 222 is a special-purpose machine specifically designed, arranged and configured to perform specific tasks including those pertaining to switching between load-based mode and frame-based mode when operating in unlicensed band in mobile communications in accordance with various implementations of the present disclosure.

In some implementations, apparatus 210 may also include a transceiver 216 coupled to processor 212. Transceiver 216 may be capable of wirelessly transmitting and receiving data. In some implementations, transceiver 216 may be capable of wirelessly communicating with different types of wireless networks of different radio access technologies (RATs). In some implementations, transceiver 216 may be equipped with a plurality of antenna ports (not shown) such as, for example, four antenna ports. That is, transceiver 216 may be equipped with multiple transmit antennas and multiple receive antennas for multiple-input multiple-output (MIMO) wireless communications. In some implementations, apparatus 220 may also include a transceiver 226 coupled to processor 222. Transceiver 226 may include a transceiver capable of wirelessly transmitting and receiving data. In some implementations, transceiver 226 may be capable of wirelessly communicating with different types of UEs/wireless networks of different RATs. In some implementations, transceiver 226 may be equipped with a plurality of antenna ports (not shown) such as, for example, four antenna ports. That is, transceiver 226 may be equipped with multiple transmit antennas and multiple receive antennas for MIMO wireless communications.

In some implementations, apparatus 210 may further include a memory 214 coupled to processor 212 and capable of being accessed by processor 212 and storing data therein. In some implementations, apparatus 220 may further include a memory 224 coupled to processor 222 and capable of being accessed by processor 222 and storing data therein. Each of memory 214 and memory 224 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 214 and memory 224 may include a type of read-only memory (ROM) such as mask ROM, programmable ROM (PROM), erasable programmable ROM (EPROM) and/or electrically erasable programmable ROM (EEPROM). Alternatively, or additionally, each of memory 214 and memory 224 may include a type of non-volatile random-access memory (NVRAM) such as flash memory, solid-state memory, ferroelectric RAM (FeRAM), magnetoresistive RAM (MRAM) and/or phase-change memory.

Each of apparatus 210 and apparatus 220 may be a communication entity capable of communicating with each other using various proposed schemes in accordance with the present disclosure. For illustrative purposes and without limitation, a description of capabilities of apparatus 210, as a UE (e.g., UE 110), and apparatus 220, as a network node (e.g., network node 125) of a wireless network (e.g., wireless network 120 as a 5G/NR mobile network), is provided below.

In one aspect of switching between load-based mode and frame-based mode when operating in unlicensed band in mobile communications in accordance with the present disclosure, processor 212 of apparatus 210, implemented in a UE (e.g., UE 110), may establish, via transceiver 216, wireless communication with a network (e.g., wireless network 120) via apparatus 220 as network node 125 in an unlicensed band. Additionally, processor 212 may determine to switch between a LBE mode and a FBE mode. Moreover, processor 212 may switch between the LBE mode and the FBE mode responsive to the determining.

In some implementations, in determining to switch between the LBE mode and the FBE mode, processor 212 may receive a message from the network via apparatus 220 to switch between the LBE mode and the FBE mode.

In some implementations, in receiving the message to switch between the LBE mode and the FBE mode, processor 212 may receive the message to switch from the LBE mode to the FBE mode. In such cases, the message may contain information comprising a FFP and a starting point of the FFP for the FBE mode. Alternatively, in receiving the message processor 212 may perform certain operations. For instance, processor 212 may receive a RRC configuration via RRC signaling or, alternatively, processor 212 may receive a SIB as part of a broadcast from the network via apparatus 220.

In some implementations, in determining to switch between the LBE mode and the FBE mode, processor 212 may perform certain operations. For instance, processor 212 may detect a condition. Additionally, processor 212 may determine to switch between the LBE mode and the FBE mode responsive to the detecting of the condition.

In some implementations, in switching between the LBE mode and the FBE mode, processor 212 may switch from the LBE mode to the FBE mode. In such cases, in detecting the condition, processor 212 may detect one or more of the following: (a) other than apparatus 210, there being no other UE operating on an operating frequency; (b) the operating frequency being occupied by multiple UEs operating in the LBE mode and using a priority class access with a same TXOP; (c) the operating frequency being occupied by a number of UEs with the number being less than a threshold; (d) a need for apparatus 210 to conserve power; and (e) one or more other UEs operating near full buffer.

Alternatively, in switching between the LBE mode and the FBE mode, processor 212 may switch from the FBE mode to the LBE mode. In such cases, in detecting the condition, processor 212 may detect one or more of the following: (a) there being high-priority data for transmission; and (b) an operating frequency is fully occupied by a plurality of UEs that are operating at different access priorities and different TXOP lengths.

In another aspect of switching between load-based mode and frame-based mode when operating in unlicensed band in mobile communications in accordance with the present disclosure, processor 222 of apparatus 220, implemented in a network node (e.g., network node 125) of a network (e.g., wireless network 120), establishing, via transceiver 226, wireless communication with a UE (e.g., apparatus 210) in an unlicensed band. Moreover, processor 222 may determine a need to switch between a LBE mode and a FBE mode. Furthermore, processor 222 may transmit, via transceiver 226, a message to apparatus 210 which is capable of driving apparatus 210 to switch between the LBE mode and the FBE mode.

In some implementations, in transmitting the message which is capable of driving apparatus 210 to switch between the LBE mode and the FBE mode, processor 222 may transmit the message which is capable of driving apparatus 210 to switch from the LBE mode to the FBE mode. In such cases, the message may contain information comprising a FFP and a starting point of the FFP for the FBE mode.

Alternatively, in transmitting the message which is capable of driving apparatus 210 to switch between the LBE mode and the FBE mode, processor 222 may transmit the message which is capable of driving apparatus 210 to switch from the FBE mode to the LBE mode.

In some implementations, in transmitting the message, processor 222 may perform certain operations. For instance, processor 222 may transmit a RRC configuration via RRC signaling or, alternatively, processor 222 may transmit a SIB as part of a broadcast by apparatus 220.

### Illustrative Processes

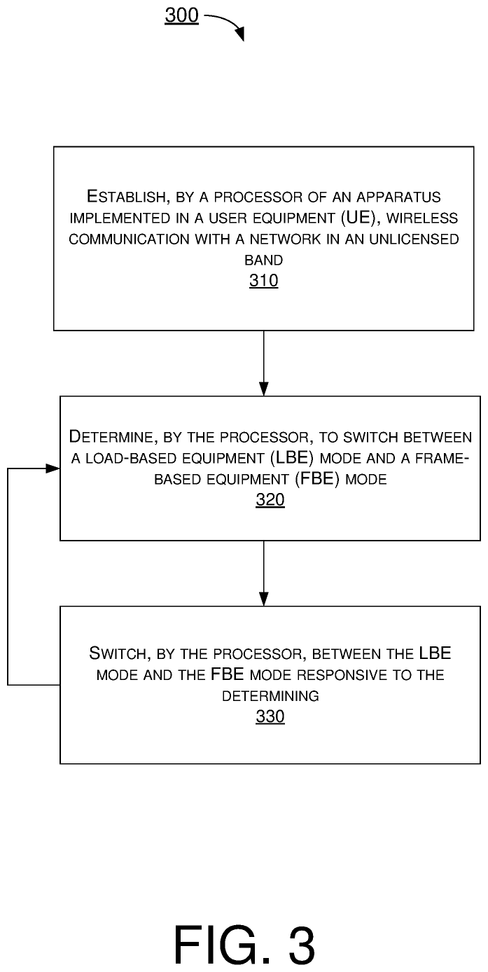

FIG. 3 illustrates an example process 300 in accordance with an implementation of the present disclosure. Process 300 may represent an aspect of implementing various proposed designs, concepts, schemes, systems and methods described above, whether partially or entirely, including those pertaining to FIG. 1 and FIG. 2. More specifically, process 300 may represent an aspect of the proposed concepts and schemes pertaining to switching between load-based mode and frame-based mode when operating in unlicensed band in mobile communications. Process 300 may include one or more operations, actions, or functions as illustrated by one or more of blocks 310, 320 and 330. Although illustrated as discrete blocks, various blocks of process 300 may be divided into additional blocks, combined into fewer blocks, or eliminated, depending on the desired implementation. Moreover, the blocks/sub-blocks of process 300 may be executed in the order shown in FIG. 3 or, alternatively in a different order. Furthermore, one or more of the blocks/sub-blocks of process 300 may be executed iteratively. Process 300 may be implemented by or in apparatus 210 and apparatus 220 as well as any variations thereof. Solely for illustrative purposes and without limiting the scope, process 300 is described below in the context of apparatus 210 as a UE (e.g., UE 110) and apparatus 220 as a communication entity such as a network node or base station (e.g., network node 125) of a wireless network (e.g., wireless network 120). Process 300 may begin at block 310.

At 310, process 300 may involve processor 212 of apparatus 210, implemented in a UE (e.g., UE 110), establishing, via transceiver 216, wireless communication with a network (e.g., wireless network 120) via apparatus 220 as network node 125 in an unlicensed band. Process 300 may proceed from 310 to 320.

At 320, process 300 may involve processor 212 determining to switch between a LBE mode and a FBE mode. Process 300 may proceed from 320 to 330.

At 330, process 300 may involve processor 212 switching between the LBE mode and the FBE mode responsive to the determining. Process 300 may proceed from 330 back to 320 as processor 212 may continuously monitor and determine whether switching between the LBE mode and the FBE mode would be required or not.

In some implementations, in determining to switch between the LBE mode and the FBE mode, process 300 may involve processor 212 receiving a message from the network via apparatus 220 to switch between the LBE mode and the FBE mode.

In some implementations, in receiving the message to switch between the LBE mode and the FBE mode, process 300 may involve processor 212 receiving the message to switch from the LBE mode to the FBE mode. In such cases, the message may contain information comprising a FFP and a starting point of the FFP for the FBE mode. Alternatively, in receiving the message, process 300 may involve processor 212 performing certain operations. For instance, process 300 may involve processor 212 receiving a RRC configuration via RRC signaling or, alternatively, process 300 may involve processor 212 receiving a SIB as part of a broadcast from the network via apparatus 220.

In some implementations, in determining to switch between the LBE mode and the FBE mode, process 300 may involve processor 212 performing certain operations. For instance, process 300 may involve processor 212 detecting a condition. Additionally, process 300 may involve processor 212 determining to switch between the LBE mode and the FBE mode responsive to the detecting of the condition.

In some implementations, in switching between the LBE mode and the FBE mode, process 300 may involve processor 212 switching from the LBE mode to the FBE mode. In such cases, in detecting the condition, process 300 may involve processor 212 detecting one or more of the following: (a) other than apparatus 210, there being no other UE operating on an operating frequency; (b) the operating frequency being occupied by multiple UEs operating in the LBE mode and using a priority class access with a same TXOP; (c) the operating frequency being occupied by a number of UEs with the number being less than a threshold; (d) a need for apparatus 210 to conserve power; and (e) one or more other UEs operating near full buffer.

Alternatively, in switching between the LBE mode and the FBE mode, process 300 may involve processor 212 switching from the FBE mode to the LBE mode. In such cases, in detecting the condition, process 300 may involve processor 212 detecting one or more of the following: (a) there being high-priority data for transmission; and (b) an operating frequency is fully occupied by a plurality of UEs that are operating at different access priorities and different TXOP lengths.

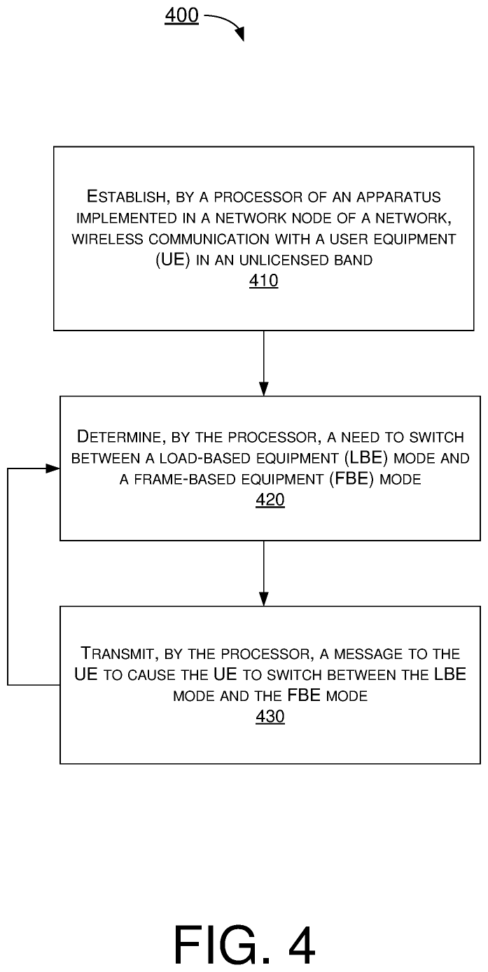

FIG. 4 illustrates an example process 400 in accordance with an implementation of the present disclosure. Process 400 may represent an aspect of implementing various proposed designs, concepts, schemes, systems and methods described above, whether partially or entirely, including those pertaining to FIG. 1 and FIG. 2. More specifically, process 400 may represent an aspect of the proposed concepts and schemes pertaining to switching between load-based mode and frame-based mode when operating in unlicensed band in mobile communications. Process 400 may include one or more operations, actions, or functions as illustrated by one or more of blocks 410, 420 and 430. Although illustrated as discrete blocks, various blocks of process 400 may be divided into additional blocks, combined into fewer blocks, or eliminated, depending on the desired implementation. Moreover, the blocks/sub-blocks of process 400 may be executed in the order shown in FIG. 4 or, alternatively in a different order. Furthermore, one or more of the blocks/sub-blocks of process 400 may be executed iteratively. Process 400 may be implemented by or in apparatus 210 and apparatus 220 as well as any variations thereof. Solely for illustrative purposes and without limiting the scope, process 400 is described below in the context of apparatus 210 as a UE (e.g., UE 110) and apparatus 220 as a communication entity such as a network node or base station (e.g., network node 125) of a wireless network (e.g., wireless network 120). Process 400 may begin at block 410.

At 410, process 400 may involve processor 222 of apparatus 220, implemented in a network node (e.g., network node 125) of a network (e.g., wireless network 120), establishing, via transceiver 226, wireless communication with a UE (e.g., apparatus 210) in an unlicensed band. Process 400 may proceed from 410 to 420.

At 420, process 400 may involve processor 222 determining a need to switch between a LBE mode and a FBE mode. Process 400 may proceed from 420 to 430.

At 430, process 400 may involve processor 222 transmitting, via transceiver 226, a message to apparatus 210 which is capable of driving apparatus 210 to switch between the LBE mode and the FBE mode. Process 400 may proceed from 430 back to 420 as processor 222 may continuously monitor and determine whether switching between the LBE mode and the FBE mode would be required or not.

In some implementations, in transmitting the message which is capable of driving apparatus 210 to switch between the LBE mode and the FBE mode, process 400 may involve processor 222 transmitting the message which is capable of driving apparatus 210 to switch from the LBE mode to the FBE mode. In such cases, the message may contain information comprising a FFP and a starting point of the FFP for the FBE mode.

Alternatively, in transmitting the message which is capable of driving apparatus 210 to switch between the LBE mode and the FBE mode, process 400 may involve processor 222 transmitting the message which is capable of driving apparatus 210 to switch from the FBE mode to the LBE mode.

In some implementations, in transmitting the message, process 400 may involve processor 222 performing certain operations. For instance, process 400 may involve processor 222 transmitting a RRC configuration via RRC signaling or, alternatively, process 400 may involve processor 222 transmitting a SIB as part of a broadcast by apparatus 220.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
establishing, by a processor of an apparatus implemented in a user equipment (UE), wireless communication with a network in an unlicensed band;
determining, by the processor, to switch between a load-based equipment (LBE) mode and a frame-based equipment (FBE) mode; and
switching, by the processor, between the LBE mode and the FBE mode responsive to the determining.

2. The method of claim 1, wherein the determining to switch between the LBE mode and the FBE mode comprises receiving a message from the network to switch between the LBE mode and the FBE mode.

3. The method of claim 2, wherein the receiving of the message to switch between the LBE mode and the FBE mode comprises receiving the message to switch from the LBE mode to the FBE mode.

4. The method of claim 3, wherein the message contains information comprising a fixed frame period (FFP) and a starting point of the FFP for the FBE mode.

5. The method of claim 2, wherein the receiving of the message comprises:
receiving a radio resource control (RRC) configuration via RRC signaling; or
receiving a system information block (SIB) as part of a broadcast from the network.

6. The method of claim 1, wherein the determining to switch between the LBE mode and the FBE mode comprises:
detecting a condition; and
determining to switch between the LBE mode and the FBE mode responsive to the detecting of the condition.

7. The method of claim 6, wherein the switching between the LBE mode and the FBE mode comprises switching from the LBE mode to the FBE mode, and wherein the detecting of the condition comprises detecting one or more of:
other than the UE, there being no other UE operating on an operating frequency;
the operating frequency being occupied by multiple UEs operating in the LBE mode and using a priority class access with a same transmit opportunity (TXOP);
the operating frequency being occupied by a number of UEs with the number being less than a threshold;
a need for the UE to conserve power; and
one or more other UEs operating near full buffer.

8. The method of claim 6, wherein the switching between the LBE mode and the FBE mode comprises switching from the FBE mode to the LBE mode, and wherein the detecting of the condition comprises detecting one or more of:
there being high-priority data for transmission; and
an operating frequency is fully occupied by a plurality of UEs that are operating at different access priorities and different transmit opportunity (TXOP) lengths.

9. A method, comprising:
establishing, by a processor of an apparatus implemented in a network node of a network, wireless communication with a user equipment (UE) in an unlicensed band;
determining, by the processor, a need to switch between a load-based equipment (LBE) mode and a frame-based equipment (FBE) mode; and
transmitting, by the processor, to the UE a message which is capable of driving the UE to switch between the LBE mode and the FBE mode.

10. The method of claim 9, wherein the transmitting of the message which is capable of driving the UE to switch between the LBE mode and the FBE mode comprises transmitting the message which is capable of driving the UE to switch from the LBE mode to the FBE mode, and wherein the message contains information comprising a fixed frame period (FFP) and a starting point of the FFP for the FBE mode.

11. The method of claim 9, wherein the transmitting of the message which is capable of driving the UE to switch between the LBE mode and the FBE mode comprises transmitting the message which is capable of driving the UE to switch from the FBE mode to the LBE mode.

12. The method of claim 9, wherein the transmitting of the message comprises:
transmitting a radio resource control (RRC) configuration via RRC signaling; or
transmitting a system information block (SIB) as part of a broadcast by the network node.

13. An apparatus implemented in a user equipment (UE), comprising:
a transceiver configured to communicate with a network; and
a processor coupled to the transceiver and configured to perform operations comprising:
establishing, via the transceiver, wireless communication with the network in an unlicensed band;
determining to switch between a load-based equipment (LBE) mode and a frame-based equipment (FBE) mode; and
switching between the LBE mode and the FBE mode responsive to the determining.

14. The apparatus of claim 13, wherein, in determining to switch between the LBE mode and the FBE mode, the processor receives, via the transceiver, a message from the network to switch between the LBE mode and the FBE mode.

15. The apparatus of claim 14, wherein, in receiving the message to switch between the LBE mode and the FBE mode, the processor receives, via the transceiver, the message to switch from the LBE mode to the FBE mode, and wherein the message contains information comprising a fixed frame period (FFP) and a starting point of the FFP for the FBE mode.

16. The apparatus of claim 14, wherein, in receiving the message to switch between the LBE mode and the FBE mode, the processor receives, via the transceiver, the message to switch from the FBE mode to the LBE mode.

17. The apparatus of claim 14, wherein, in receiving the message, the processor either:
receives, via the transceiver, a radio resource control (RRC) configuration via RRC signaling; or
receives, via the transceiver, a system information block (SIB) as part of a broadcast from the network.

18. The apparatus of claim 13, wherein, in determining to switch between the LBE mode and the FBE mode, the processor performs operations comprising:
detecting a condition; and
determining to switch between the LBE mode and the FBE mode responsive to the detecting of the condition.

19. The apparatus of claim 18, wherein, in switching between the LBE mode and the FBE mode, the processor switches from the LBE mode to the FBE mode, and wherein, in detecting the condition, the processor detects, via the transceiver, one or more of:
other than the UE, there being no other UE operating on an operating frequency;
the operating frequency being occupied by multiple UEs operating in the LBE mode and using a priority class access with a same transmit opportunity (TXOP);
the operating frequency being occupied by a number of UEs with the number being less than a threshold;
a need for the UE to conserve power; and
one or more other UEs operating near full buffer.

20. The apparatus of claim 18, wherein, in switching between the LBE mode and the FBE mode, the processor switches from the FBE mode to the LBE mode, and wherein, in detecting the condition, the processor detects, via the transceiver, one or more of:
there being high-priority data for transmission; and
an operating frequency is fully occupied by a plurality of UEs that are operating at different access priorities and different transmit opportunity (TXOP) lengths.
